(19) United States
(12) Patent Application Publication
(10) Pub. No.: US 2010/0111055 A1
(43) Pub. Date: May 6, 2010

(54) WIRELESS ACCESS POINT, WIRELESS NETWORK ARCHITECTURE, AND METHOD FOR ESTABLISHING WIRELESS NETWORK ARCHITECTURE

(75) Inventors: Ching Chuan Chiu, Taipei (TW); Ten Long Dan, Taipei (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: ASUSTeck Computer Inc., Taipei (TW)

(21) Appl. No.: 12/486,673

(22) Filed: Jun. 17, 2009

(30) Foreign Application Priority Data
Nov. 5, 2008 (TW) 097142751

(51) Int. Cl. H04W 84/02

(52) U.S. Cl. 370/338

(57) ABSTRACT

The invention provides a wireless access point, a wireless network architecture, and a method for establishing the wireless network architecture. The method of the invention includes the following steps. First a first wireless access point and a second wireless access point are defined. Second a first function mode of the first wireless access point is set to be a router mode. Third a second function mode of the second wireless access point is set to be a wireless access point mode, a repeater mode or an adapter mode. Fourth a communication connection is established between the first wireless access point and the second wireless access point to perform a data exchange procedure. At last, a plurality of operational parameters of the second wireless access point are set by the second wireless access point itself according to the second function mode to finish the establishment of the wireless network architecture.

### BACKGROUND OF THE INVENTION

1. Field of the Invention

The invention relates to a wireless access point, a wireless network architecture, and a method for establishing the wireless network architecture and, more particularly, to a wireless access point whose modes may be switched without a browser, a wireless network architecture including the wireless access point, and a method for establishing a wireless network architecture based on the wireless access point.

2. Description of the Prior Art

Since the Institute of Electrical and Electronics Engineers published the IEEE 802.11 standard of wireless network in June, 1997, transmission speed and stability of wireless network are improved as related technology improves continuously and related equipment develops quickly. Furthermore, a wireless network is convenient to use without physical wiring. Therefore, it becomes popular and preferred network connection mean of users under considerations of cost, connection speed and convenience.

In short, wireless network architecture mainly includes a user terminal and a wireless access point. A wireless card is fixed on the user terminal and the wireless access point is connected to backbone network such as the Internet. The user terminal is connected to the wireless access point in a manner similar to radio communication via the wireless card, and then it may be connected to the backbone network via the wireless access point to use network resource.

Although the wireless network has an advantage of being online anytime anywhere, the strength of the signals of the wireless card and the wireless access point can be easily weaken under the interference of barriers. Therefore, if the wireless network needs to be used seamless in larger space, more than one wireless access point is always needed to be set.

Conventionally, when a user has two wireless access points to be connected in series, the first wireless access point is always set in a router mode, and the second wireless access point can be set in a wireless access point mode, a repeater mode or an adapter mode to achieve different effects.

FIG. 1A to FIG. 1C are schematic diagrams of wireless network architecture in the prior art. As shown in FIG. 1A to FIG. 1C, the wireless network architecture 7 in the prior art mainly includes the first wireless access point 70 and the second wireless access point 72. The first wireless access point 70 is connected to the Internet 8. The second wireless access point 72 is connected to a first electronic device 74 to make the first electronic device 74 connected to the Internet 8 via the second wireless access point 72 and the first wireless access point 70 in order. Furthermore, the second wireless access point 72 is usually connected to the second electronic device 76 via a network cable. Therefore, a user can set the second wireless access point 72 via the second electronic device 76.

As shown in FIG. 1A, when a user wants to set the second wireless access point 72 in the wireless access point mode, he performs the following steps. First, he connects the second electronic device 76 to the second wireless access point 72 via the network cable. Second, he sets parameters such as an IP address, an account and a password of the second electronic device 76 and sets the second wireless access point 72 in the wireless access point mode in firmware. Third, he sets parameters of the second wireless access point 72 such as a SSID, an encryption mode and a password. At last, he connects the second wireless access point 72 with the first wireless access point 70 via a network cable to finish settings.

As shown in FIG. 1B, when a user wants to set the second wireless access point 72 in the repeater mode, he performs the following steps. First, he connects the second electronic device 76 to the second wireless access point 72 via the network cable. Second, he sets parameters such as an IP address, an account and a password and sets the second wireless access point 72 in the repeater mode in firmware. Third, he sets the parameters of the second wireless access point 72 such as a SSID and a password as the same as the parameters of the first wireless access point 70 to finish settings.

Furthermore, as shown in FIG. 1C, when the user wants to set the second wireless access point 72 in the adapter mode, he performs the following steps. First, he connects the second electronic device 76 to the second wireless access point 72 via the network cable. Second, he sets the parameters such as an IP address, an account and a password and sets the related parameters of the first wireless access point 70 in firmware. At last, he connects the second wireless access point 72 with the first electronic device 74 via the network cable to finish settings.

The modes of a conventional wireless access point may be switched as stated above to provide users with more selections for the network structure. However, the modes are changed by setting parameters in the firmware of the wireless access point via a browser, and it is inconvenient and a waste of time for users.

### SUMMARY OF THE INVENTION

Accordingly, an aspect of the invention is to provide a method for establishing the wireless network architecture to solve the problems in prior art.

According to an embodiment of the invention, the method includes the following steps.

First, a first wireless access point and a second wireless access point are defined. Wherein the first wireless access point includes a first switch for switching a first function mode of the first wireless access point, and the second wireless access point includes a second switch for switching a second function mode of the second wireless access point.

Second, the first function mode is set to be a router mode via the first switch.

Third, the second function mode is set to be a wireless access point mode, a repeater mode or an adapter mode via the second switch.

Fourth, a communication connection between the first wireless access point and the second wireless access point is established to perform a data exchange procedure.

At last a plurality of operational parameters of the second wireless access point are set by the second wireless access point itself according to the second function mode to finish the establishment of the wireless network architecture.

Another aspect of the invention is to provide a wireless network architecture to solve the problems in prior art.

According to an embodiment of the invention, the wireless network architecture includes a first wireless access point, a second wireless access point and a user terminal. The first wireless access point is connected to the Internet and it includes a first switch for switching a first function mode of the first wireless access point to a router mode. A communication connection is established between the second wireless access point and the first wireless access point to perform a data exchange procedure. And the second wireless access point includes a second switch for switching a second function mode of the second wireless access point to a wireless access point mode, a repeater mode or an adapter mode. The user terminal is connected to the second wireless access point, and is connected to the Internet via the second wireless access point and the first wireless access point in order.

Another aspect of the invention is to provide a wireless access point to solve the problems in prior art.

According to an embodiment of the invention, the wireless access point includes a switch, a control element and a processor. The switch is used for switching a plurality of function modes of the wireless access point. The control element is used for generating a drive signal to control the wireless access point and the main wireless access point to perform a data exchange procedure when a communication connection is established between the wireless access point and a main wireless access point. The processor is used for setting a plurality of operational parameters of the wireless access point according to the function mode. Specially, the function modes include a router mode, a wireless access point mode, a repeater mode and an adapter mode.

These and other features, aspects and advantages of the present invention will become better understood with regard to the following description, appended claims, and accompanying drawings.

### BRIEF DESCRIPTION OF THE APPENDED DRAWINGS

FIG. 1A to FIG. 1C are schematic diagrams of wireless network architecture in the prior art;

FIG. 2A is a schematic diagram of the wireless access point of the invention;

FIG. 2B is a block diagram of the wireless access point of the invention;

FIG. 3 is a flow chart of the method for establishing the wireless network architecture of an embodiment of the invention;

FIG. 4A is a flow chart of the method for establishing the wireless network architecture of an embodiment of the invention;

FIG. 4B is a schematic diagram of the wireless network architecture of an embodiment of the invention;

FIG. 5A is a flow chart of the method for establishing the wireless network architecture of an embodiment of the invention;

FIG. 5B is a schematic diagram of the wireless network architecture of the embodiment of the invention;

FIG. 6A is a flow chart of the method for establishing the wireless network architecture of an embodiment of the invention; and

FIG. 6B is a schematic diagram of the wireless network architecture of an embodiment of the invention.

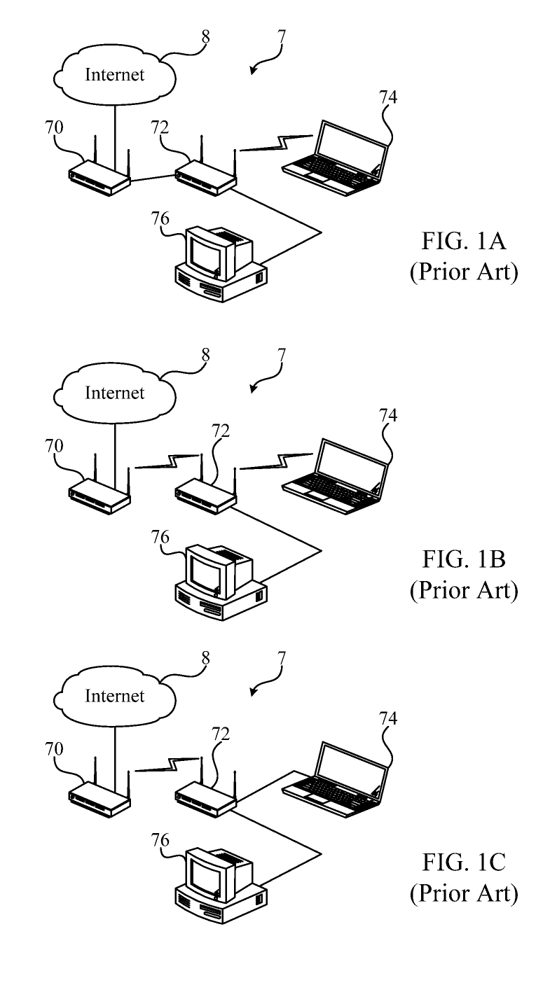

### DETAILED DESCRIPTION OF THE INVENTION

The invention provides a wireless access point whose modes may be switched without a browser, a wireless network architecture including the wireless access point, and a method for establishing a wireless network architecture based on the wireless access point.

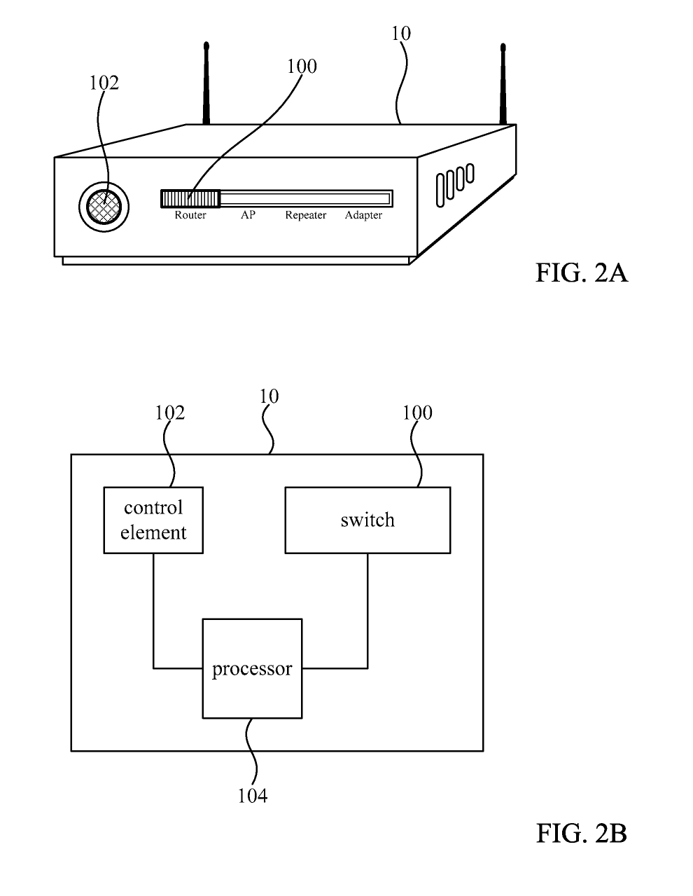

FIG. 2A is a schematic diagram of the wireless access point of the invention and FIG. 2B is a block diagram of the wireless access point of the invention. As shown in FIG. 2A and FIG. 2B, the wireless access point 10 of the invention includes a switch 100, a control element 102 and a processor 104.

The switch 100 is used for switching a plurality of function modes of the wireless access point 10. As shown in FIG. 2A and FIG. 2B, the function modes can be a router mode, a wireless access point mode, a repeater mode and an adapter mode.

The control element 102 generates a drive signal to control the wireless access point 10 and a main wireless access point to perform a data exchange procedure when a communication connection is established between the wireless access point 10 and the main wireless access point (not shown). As shown in FIG. 2A, the control element 102 is designed to be a button, but the control element 102 may be also designed to have other proper types in practice. Therefore, the invention is not limited thereto.

The processor 104 is used for setting a plurality of operational parameters of the wireless access point 10 according to the function mode. In actual application, the wireless access point 10 further includes the functional elements such as a calculation module, a storage module, a communication module and a power module. Since these elements are well known by persons having ordinary skill in the art, they are not described for a concise purpose. Furthermore, in actual application, the types of the switch 100 and the control element 102 and the positions thereof in the wireless access point 10 can be adjusted circumstantially, and the invention is not limited thereto.

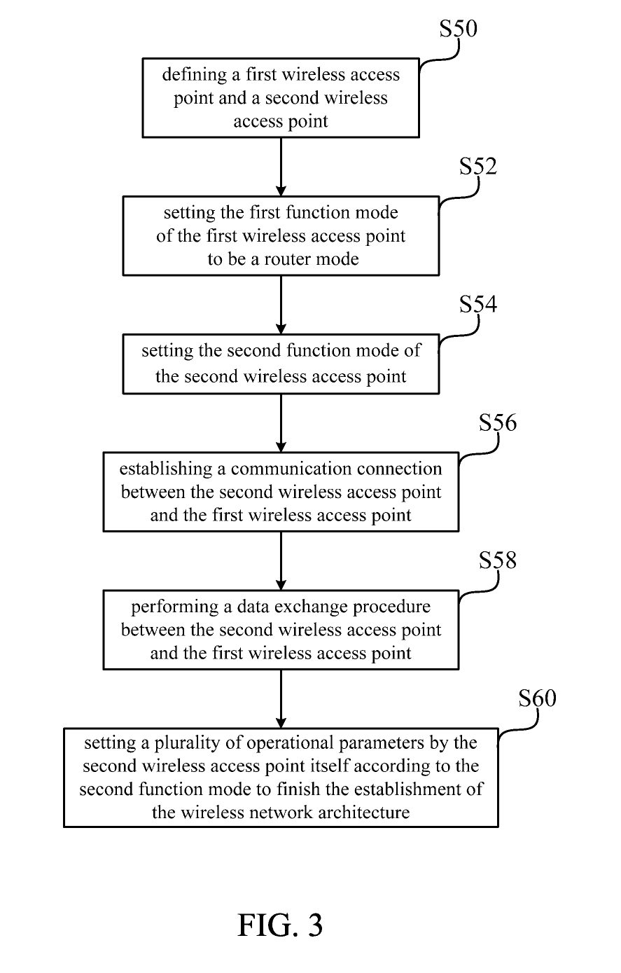

FIG. 3 is a flow chart of the method for establishing the wireless network architecture of an embodiment of the invention. As shown in FIG. 3, the method of the invention mainly includes the following steps.

First, at step S50, a first wireless access point and a second wireless access point are defined. In actual application, the first wireless access point and the second wireless access point may be the wireless access points of the invention as stated above. However, the first wireless access point also may be other type of wireless access point in practice.

Second, at step S52, a first function mode of the first wireless access point is set to be the router mode. At step S54, a second function mode of the second wireless access point is set. The second function mode is a wireless access point mode, a repeater mode, an adapter mode or other proper mode.

Third, at step S56, a communication connection is established between the second wireless access point and the first wireless access point. At step S58, a data exchange procedure is performed between the second wireless access point and the first wireless access point. In actual application, the second wireless access point exchanges encryption modes or other proper data with the first wireless access point in the data exchange procedure.

At last, at step S60, a plurality of operational parameters of the second wireless access point are set by the second wireless access point itself according to the second function mode to finish the establishment of the wireless network architecture. The operational parameters include a service set identifier, encrypted information or other proper parameters in practice. Furthermore, the second wireless access point can set the operational parameters by itself or use the operational parameters of the first wireless access point directly. It is determined according to the function mode.

The following embodiment is described by taking the wireless access point in FIG. 2A as the wireless network architecture, so that the switch and the control element are the same as the ones in FIG. 2A. They are not described for a concise purpose.

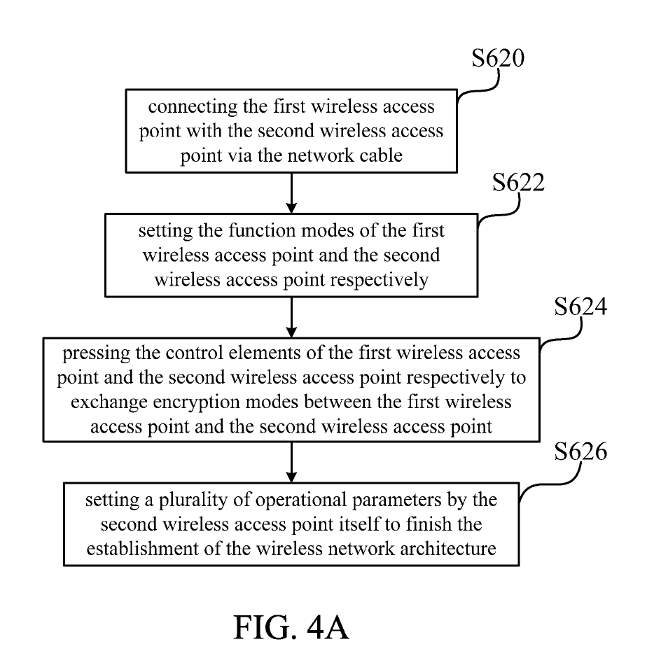

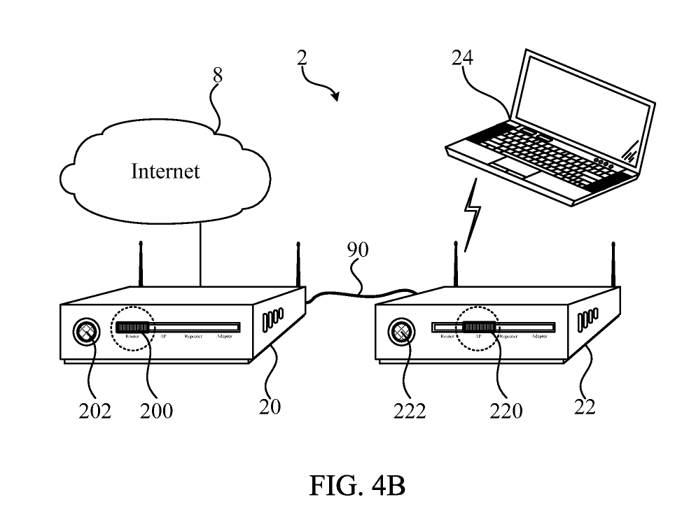

FIG. 4A is a flow chart of the method for establishing the wireless network architecture of an embodiment of the invention, and FIG. 4B is a schematic diagram of the wireless network architecture of the embodiment.

As shown in FIG. 4A and FIG. 4B, the wireless network architecture 2 includes a first wireless access point 20 and a second wireless access point 22. The first wireless access point 20 is connected to the Internet 8, and the second wireless access point 22 is connected to a user terminal 24 to make the user terminal 24 connect to the Internet 8 via the second wireless access point 22 and the first wireless access point 20 in order. The first wireless access point 20 is set in the router mode (shown in the dotted-circle) and the second wireless access point 22 is set in the wireless access point mode (shown in the dotted-circle) via the switch 200 and the switch 220 respectively.

As shown in FIG. 4A and FIG. 4B, the method for establishing the wireless network architecture 2 of the embodiment includes the following steps. The first wireless access point 20 and the second wireless access point 22 are connected via a network cable 90 at step S620. The first wireless access point 20 and the second wireless access point 22 are set in the said function modes (shown in the dotted-circles) at step S622. The control element 202 of the first wireless access point 20 and the control element 222 of the second wireless access point 22 are pressed, respectively, (sequentially or at the same time) to exchange encryption modes between the first wireless access point 20 and the second wireless access point 22 at step S624. A plurality of operational parameters of the second wireless access point 22 (that is the operational parameters related to the wireless access point mode) are set by the second wireless access point 22 itself to finish the establishment of the wireless network architecture 2 at step 626.

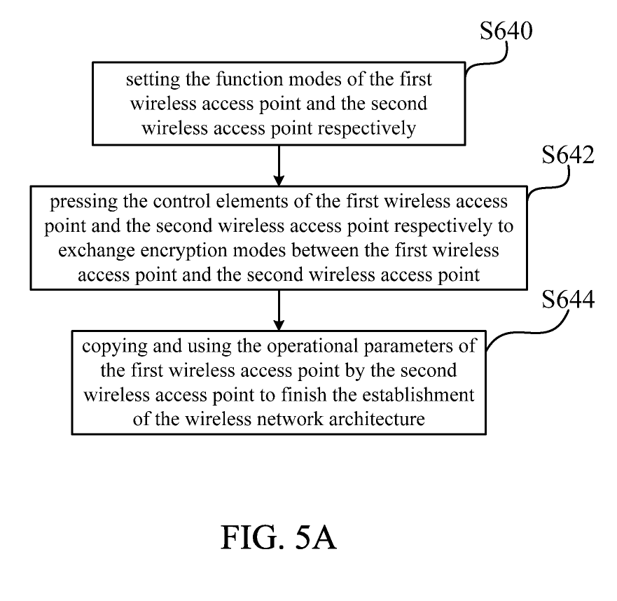

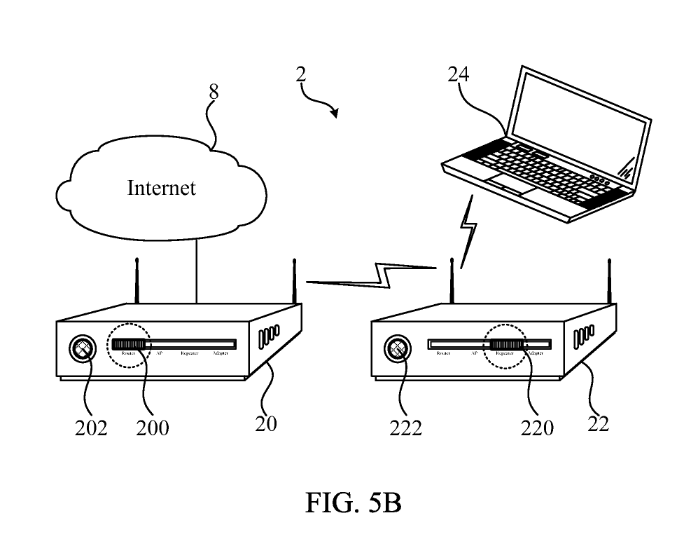

FIG. 5A is a flow chart of the method for establishing the wireless network architecture of an embodiment of the invention, and FIG. 5B is a schematic diagram of the wireless network architecture of the embodiment.

As shown in FIG. 5A and FIG. 5B, the wireless network architecture 2 includes a first wireless access point 20 and a second wireless access point 22. The first wireless access point 20 is connected to the Internet 8, and the second wireless access point 22 is connected to a user terminal 24 to make the user terminal 24 connect to the Internet 8 via the second wireless access point 22 and the first wireless access point 20 in order. The first wireless access point 20 is set in the router mode (shown in the dotted-circle), and the second wireless access point 22 is set in the repeater mode (shown in the dotted-circle) via the switch 200 and switch 220, respectively.

As shown in the FIG. 5A and FIG. 5B, the method for establishing the wireless network architecture 2 of the embodiment includes the following steps. The first wireless access point 20 and the second wireless access point 22 are set in the said function modes (shown in the dotted-circles) at step S640. The control element 202 of the first wireless access point 20 and the control element 222 of the second wireless access point 22 are pressed, respectively, (sequentially or at the same time) to exchange encryption modes between the first wireless access point 20 and the second wireless access point 22 at step S642. The second wireless access point 22 copies and uses the operational parameters of the first wireless access point 20 (that is the operational parameters related to the repeater mode, such as a SSID, encrypted information, but it is not limited thereto.) to finish the establishment of the wireless network architecture 2 at step S644.

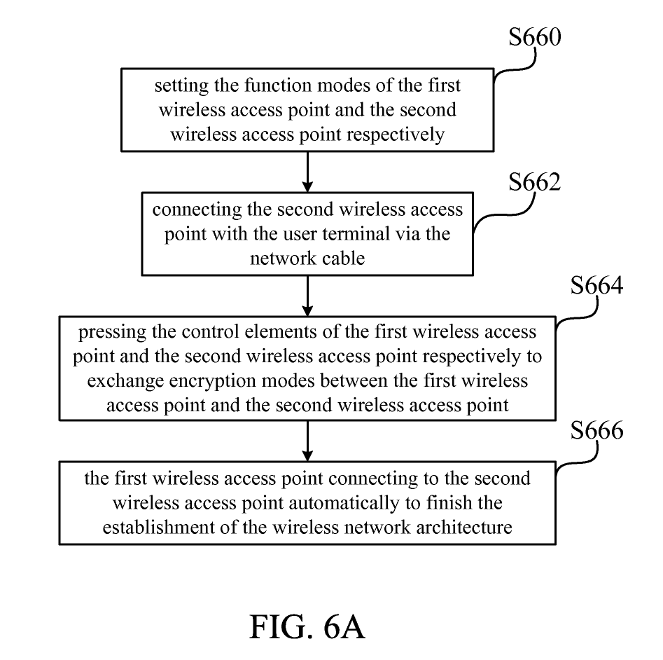

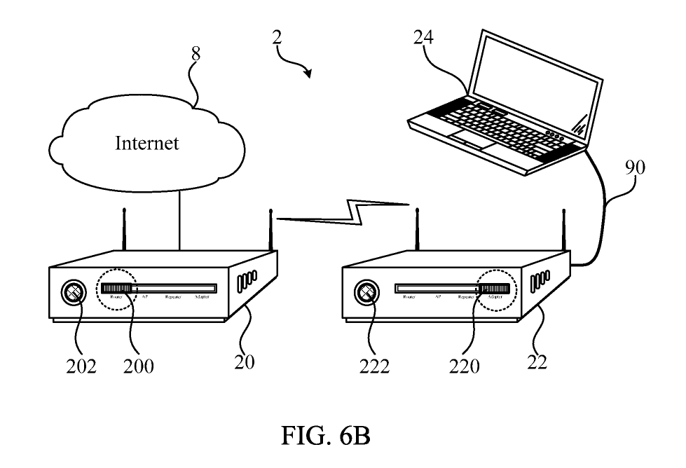

FIG. 6A is a flow chart of the method for establishing the wireless network architecture of an embodiment of the invention, and FIG. 6B is a schematic diagram of the wireless network architecture of the embodiment.

As shown in the FIG. 6A and FIG. 6B, the wireless network architecture 2 includes a first wireless access point 20 and a second wireless access point 22. The first wireless access point 20 is connected to the Internet 8, and the second wireless access point 22 is connected to a user terminal 24 to make the user terminal 24 connect to the Internet 8 via the second wireless access point 22 and the first wireless access point 20 in order. The first wireless access point 20 is set in the router mode (shown in the dotted-circle) and the second wireless access point 22 is set in the adapter mode (shown in the dotted-circle) via the switch 200 and switch 220, respectively.

As shown in the FIG. 6A and FIG. 6B, the method for establishing the wireless network architecture 2 of the embodiment includes the following steps. The first wireless access point 20 and the second wireless access point 22 are set in the said function modes (shown in the dotted-circles) at step S660. The second wireless access point 22 is connected with the user terminal 24 via a network cable 90 at step S662. The control element 202 of the first wireless access point 20 and the control element 222 of the second wireless access point 22 are pressed, respectively, (sequentially or at the same time) to exchange encryption modes between the first wireless access point 20 and the second wireless access point 22 at step S664. The first wireless access point 20 is connected to the second wireless access point 22 automatically to finish the establishment of the wireless network architecture 2 at step S666.

The wireless network architecture only having two wireless access points is taken as an example in the above embodiments. However, the wireless network architecture of the invention also may include a plurality of wireless access points in different function modes if necessary.

As stated above, the wireless access point of the invention includes a switch, a control element and a processor with improved functions. Therefore, a user switches the function mode of the wireless access point via the switch and synchronizes wireless access points via the control elements to finish the establishment of the wireless network architecture. Since it is unnecessary to connect the wireless access points via a computer and set a password, encrypted information, operational parameters and other firmware manually as in prior art, the method in the invention is simple.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A method for establishing a wireless network architecture, comprising the steps of:
defining a first wireless access point and a second wireless access point, wherein the first wireless access point comprises a first switch for switching a first function mode of the first wireless access point, and the second wireless access point comprises a second switch for switching a second function mode of the second wireless access point;
setting the first function mode to be a router mode via the first switch;
setting the second function mode to be a wireless access point mode, a repeater mode or an adapter mode via the second switch;
establishing a communication connection between the first wireless access point and the second wireless access point to perform a data exchange procedure; and
setting a plurality of operational parameters of the second wireless access point by the second wireless access point itself according to the second function mode to finish the establishment of the wireless network architecture.

2. The method according to claim 1, wherein the first wireless access point is connected to the internet, and the second wireless access point is connected to a user terminal.

3. The method according to claim 1, wherein when the second function mode is the wireless access point mode, the communication connection is a wired communication connection, and the data exchange procedure further comprises the step of:
exchanging encryption modes between the first wireless access point and the second wireless access point.

4. The method according to claim 1, wherein when the second function mode is the repeater mode, the communication connection is a wireless communication connection, and the data exchange procedure further comprises the step of:
exchanging encryption modes between the first wireless access point and the second wireless access point.

5. The method according to claim 4, further comprising the step of:
copying and using a plurality of operational parameters of the first wireless access point by the second wireless access point.

6. The method according to claim 1, wherein when the second function mode is the adapter mode, the communication connection is a wireless communication connection, and the method further comprises the step of:
connecting a user terminal to the second wireless access point via a wired communication connection.

7. The method according to claim 6, wherein the data exchange procedure further comprises the step of:
exchanging encryption modes between the first wireless access point and the second wireless access point.

8. The method according to claim 7, further comprising the step of:
connecting the user terminal to the internet via the second wireless access point and the first wireless access point in order.

9. The method according to claim 1, wherein the operational parameters comprise a service set identifier and an encryption information.

10. A wireless network architecture, comprising:
a first wireless access point comprising a first switch for switching a first function mode of the first wireless access point to a router mode, wherein the first wireless access point is connected to the internet;
a second wireless access point comprising a second switch for switching a second function mode of the second wireless access point to a wireless access point mode, a repeater mode or an adapter mode, wherein a communication connection is established between the second wireless access point and the first wireless access point to perform a data exchange procedure; and
a user terminal connected to the second wireless access point, wherein the user terminal is connected to the internet via the second wireless access point and the first wireless access point in order.

11. The wireless network architecture according to claim 10, wherein when the second function mode is the wireless access point mode, the communication connection is a wired communication connection, and the first wireless access point exchanges an encryption mode with the second wireless access point via the data exchange procedure.

12. The wireless network architecture according to claim 10, wherein when the second function mode is the repeater mode, the communication connection is a wireless communication connection, and the first wireless access point exchanges an encryption mode with the second wireless access point via the data exchange procedure.

13. The wireless network architecture according to claim 12, wherein the second wireless access point copies and uses a plurality of operational parameters of the first wireless access point.

14. The wireless network architecture according to claim 13, wherein the operational parameters comprise a service set identifier and an encryption information.

15. The wireless network architecture according to claim 10, wherein when the second function mode is the adapter mode, the communication connection is a wireless communication connection, and the first wireless access point exchanges an encryption mode with the second wireless access point via the data exchange procedure.

16. A wireless access point, comprising:
a switch for switching a plurality of function modes of the wireless access point;
a control element for generating a drive signal when the wireless access point establishes a communication connection with a main wireless access point to control the wireless access point and the main wireless access point to perform a data exchange procedure; and
a processor for setting a plurality of operational parameters of the wireless access point according to the function mode;
wherein the function modes comprises a router mode, a wireless access point mode, a repeater mode and an adapter mode.

17. The wireless access point according to claim 16, wherein when the switch switches the wireless access point to the wireless access point mode, the communication connection is a wired communication connection, and the wireless access point exchanges an encryption mode with the main wireless access point via the data exchange procedure.

18. The wireless access point according to claim 16, wherein when the switch switches the wireless access point to the repeater mode, the communication connection is a wireless communication connection, and the wireless access point exchanges an encryption mode with the main wireless access point via the data exchange procedure.

19. The wireless access point according to claim 18, wherein the processor copies and uses a plurality of operational parameters of the main wireless access point.

20. The wireless access point according to claim 16, wherein when the function mode is the adapter mode, the communication connection is a wireless communication connection, and the wireless access point exchanges an encryption mode with the main wireless access point via the data exchange procedure.

21. The wireless access point according to claim 20, wherein the wireless access point is connected to a user terminal via a wired communication connection to make the user terminal connect to the internet via the wireless access point and the main wireless access point in order.

22. The wireless access point according to claim 16, wherein the operational parameters comprises a service set identifier and an encryption information.
